(19) United States
(12) Patent Application Publication
(10) Pub. No.: US 2006/0250731 A1
(43) Pub. Date: Nov. 9, 2006

(54) System and method for electrostatic discharge protection in an electronic circuit

(76) Inventors: Ray M. Parkhurst, Fremont, CA (US); Ron Ruebusch, Saratoga, CA (US); Chi Jiaa, San Jose, CA (US); Janet Sickler, Morgan Hill, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/121,401

(22) Filed: May 3, 2005

(51) Int. Cl. H02H 9/00

(52) U.S. Cl. 361/56

(57) ABSTRACT

A system and method for implementing an electronic circuit for protecting electronic components from ESD. A PCB or IC may include an electrostatic discharge protection layer having a first and second conductive layer separated by a semi-conductive dielectric layer. Further, the PCB/IC may include a protected node coupled to the first conductive layer and a current-shunt node electrically coupled to the second conductive layer, such that a signal at the protected node that is below a threshold magnitude propagates through the protected node in a normal operating path and a signal at the protected node that exceeds a threshold magnitude is diverted to the semi-conductive dielectric layer to the current-shunt node in a current-shunt path. In this manner, existing layers of a PCB/IC may be used for both ESD protection and other functions, such as ground planes or battery plane by isolating the specific sections of the layer for its intended use.

### BACKGROUND OF THE INVENTION

Static electricity or static charge is the accumulated electric charge of an object that is typically an electric potential stored in the surface of the object that will discharge when presented with a conductive path to another object or ground. This electrostatic discharge (ESD) may create a transient voltage that, in turn, induces a transient current that may exceed maximum capacity thresholds for typical electronic circuits, thus, causing irreparable damage to sensitive electronic circuits and any associated components. Hence, this is the reason why printed circuit boards are always packaged and handled with anti-static plastic coverings. Additionally, typical electronic circuits include some form of ESD protection devices dealing with high-level transients.

FIG. 1 is a conventional schematic diagram of an electronic circuit 100 having a typical ESD protection device that may be used to protect a component from excessive current levels that may result from ESD. In FIG. 1, a protected component 110 may include a protected node 130 and a current-shunt node 131 for realizing part of an ESD protection scheme for an electronic circuit. The protected node may typically be an exposed signal node such as an antennae or a battery terminal that may be subject to an external ESD. Thus, an ESD protection device 120 is also electrically coupled between the protected node 130 and the current-shunt node 131 to provide a current-shunt path when high-level transient currents are present that may result from ESD.

Typically, an ESD protection device 120 is designed to appear as an open circuit when low-voltage, low-current, steady-state signals are present at the protected node 130. Conversely, the ESD protection device 120 is designed to appear to be a short circuit when high-voltage, high-current, transient signals are present on the protected node 130. As such, when operating normally, signals at the protected node 130 may propagate normally as though the ESD protection device 120 is not part of the overall circuit 100. When a threshold (either voltage or current) is exceeded, however, the ESD protection device 120 is “activated” and diverts high-level, transient signals away from the protected component 110 through the current-shunt node 131 and eventually to point in the circuit 100 capable of handling the excessive transient signals, such as ground or a battery.

For example, an ESD event may cause a high-level transient voltage (typically as much as 16 kV) that will eventually cause damage to the protected component 110. However, the current that may be induced at the protected node 130 as a result of the 1 6kV ESD causes the ESD protection device 120 to trigger thus, diverting the high currents through the ESD protection device 120 to the current-shunt node 131 which may typically be a ground node. Thus, the unsafe currents are dissipated before having a chance to cause damage to the protected component 110.

Various types of ESD protection devices 120 are known in the art. Examples of such devices include diode clamps to ground, diode clamps to battery, and various networks of ESD protection that utilize resistor-diode clamps and active core-shunt clamps. In each of theses cases, however, these ESD protection devices are fabricated as part of an integrated circuit (IC) and require extensive die area to be realized because of the nature of the components, i.e., diodes, resistors, etc. When dealing with limited space in an IC, die area becomes an issue such that the ESD protection scheme may suffer for lack of available space on the IC. Furthermore, these ESD devices are typically only realized on the top surface of the IC, thus requiring extensive signal routing for optimal ESD protection.

In another past solution, the above-described ESD protection devices can be realized as surface-mount technology (SMT) devices. That is, the implementations of these ESD protection devices are mounted to the PCB and require pin-outs and/or pads on the PCB to interface with other components of the PCB. However, PCB space is again an issue as each additional SMT device requires at least one pin-out or pad to pass electrical signals to and from the PCB. Furthermore, SMT devices are more expensive and increase the size of the package surrounding the PCB because of the additional space off chip required by the SMT devices. Signal routing in the PCB also remains a problem.

In yet another solution of the past, an ESD protection scheme may be realized through a “gasket layer” that may be fabricated along with the PCB. The gasket layer provides matrix-connected paths for ESD currents between various signal points and a respective ground path, battery path, or other signal path. However, the gasket layer, having two conductive layers, must be used strictly for ESD protection due to signals being routed using both conductive layers of the gasket layer. Thus, not only is the additional layer completely used for only ESD protection, it may not be used for other purposes, such as routing of battery or ground signals. Furthermore, the routing paths for ESD currents is longer and, thus, more inductive and resistive than what is ideally desired.

Each of the above solutions of the past require additional area in precious board or die space and are, thus, undesirable as a means of providing ESD protection to PCBs and associated electrical components. Furthermore, the routing paths for each of the above solutions remains longer than is desirable which adds complexity, resistance, and inductance to the discharge paths. Additionally, longer routing paths, increased board or die space, and additional layers all add to the cost of product design and fabrication. A more optimal solution with shorter discharge paths for ESD currents in a PCB is desirable.

### SUMMARY OF THE INVENTION

An embodiment of the invention is directed to an electronic circuit for protecting electronic components from electrostatic discharge. A PCB or an IC may include an electrostatic discharge protection layer having a first and second conductive layer separated by a semi-conductive dielectric layer. Further, the PCB or IC may include a protected node electrically coupled to the first conductive layer and a current-shunt node electrically coupled to the second conductive layer, such that a signal at the protected node that is below a threshold magnitude propagates through the protected node in a normal operating path and a signal at the protected node that exceeds a threshold magnitude is diverted to propagate through the semi-conductive dielectric layer to the current-shunt node in a current-shunt path. In this manner, existing layers of a PCB or IC may be used for both ESD protection and other functions, such as ground planes or battery plane by isolating the specific sections of the layer for its intended use.

Utilizing existing layers in a PCB or IC to realize an ESD protection scheme is advantageous for a number of reasons. For one, no additional layers need to be fabricated for the sole purpose of providing ESD protection. Furthermore, signal routing and signal paths become less complicated and intrusive as typically the ground plane and the battery plane are often prevalent throughout all areas of the PCB or IC. As a result, the circuitry of the PCB or IC becomes less complicated which results in less labor-intensive design and fabrication and smaller PCBs and/or ICs. Both of these advantages, in turn, result in cheaper fabrication and design, as well. Depending on the particular routing of the ESD scheme, a more robust dissipation region may be realized within the PCB or IC because of the nature of the semi-conductive dielectric material and its proximity to several ground nodes. Finally, space and money is saved by not having any SMT devices required as part of an ESD protection scheme.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a conventional schematic diagram of an electronic circuit having a typical ESD protection device that may be used to protect a component from excessive current levels that may result from ESD;

FIG. 2 is a cutaway view of a PCB for diverting electrostatic discharge signals away from electronic components and the like according to an embodiment of the invention;

FIG. 3 is a cutaway view of a PCB showing a shunted ESD signal path between a signal node and a ground node according to another embodiment of the invention;

FIG. 4 is a cutaway view of a PCB showing a shunted ESD signal path between a signal node and a battery node according to another embodiment of the invention;

FIG. 5 is a cutaway view of a PCB or IC showing a first stage and a second stage shunted ESD signal path between a first node and a second node according to yet another embodiment of the invention;

FIG. 6 is a cutaway view of a PCB showing a first stage and a second stage shunted ESD signal path between a first node and a second node wherein the second stage shunted ESD signal path includes an SMT device according to yet another embodiment of the invention; and

FIG. 7 is a block diagram of an electronic system that includes a protected electronic component and a PCB or IC having a configuration for diverting ESD signals away from the protected circuit according to an embodiment of the invention.

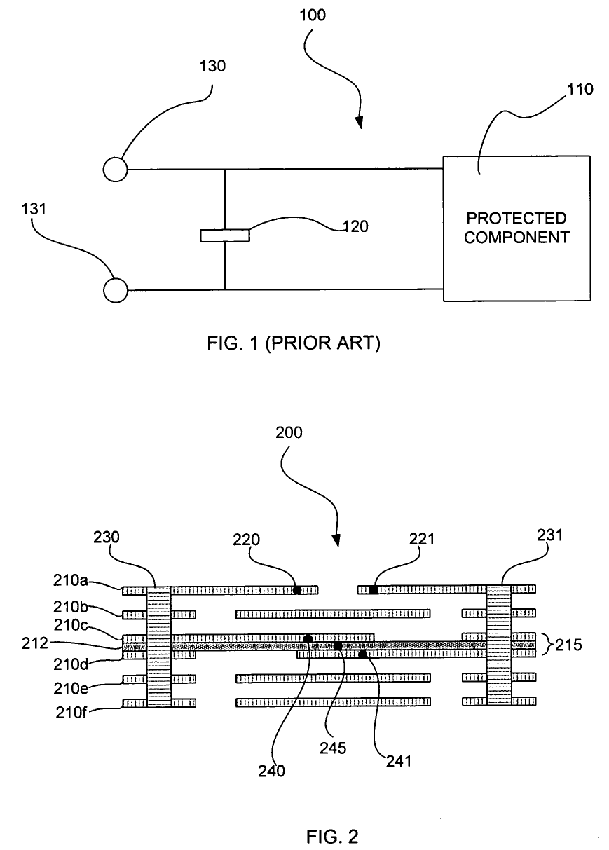

### DETAILED DESCRIPTION

The following discussion is presented to enable a person skilled in the art to make and use the invention. The general principles described herein may be applied to embodiments and applications other than those detailed above without departing from the spirit and scope of the present invention. The present invention is not intended to be limited to the embodiments shown, but is to be accorded the widest scope consistent with the principles and features disclosed or suggested herein.

FIG. 2 is a cutaway view of a PCB 200 for diverting electrostatic discharge signals away from electronic components and the like according to an embodiment of the invention. A typical PCB 200 may include several layers 210 that may be fabricated to realize various interconnections and signal paths to, from, and through the PCB. In the embodiment of FIG. 2, the PCB 200 is shown with six distinct conductive plane layers 210a-210f. In this disclosure, these layers 210a-210f are simply named layers 1-6 starting from the top. One skilled in the art understands that the invention may be practiced in PCBs having more or less layers and the embodiment showing six layers 210a-210f is in no way a limitation on the invention.

In this embodiment, layer 3 210c and layer 4 210d may be fabricated to have a semi-conductive dielectric 212 between them. The semi-conductive dielectric 212 may be a polymer-based formulation or polymeric solution designed to have specific electrical characteristics that provide ESD protection capabilities. The semi-conductive dielectric 212 is formulated to be sensitive to high-level transient signals such that an ESD surge event or other similar transient disturbance will invoke the conductive nature of the semi-conductive dielectric 212. When not is an ESD event situation, the semi-conductive dielectric 212 remains non-conductive. Collectively, layer 3 210c, layer 4 210d, and the semi-conductive dielectric 212 may be referred to as the ESD protection device layer 215.

In the ESD protection device layer 215, there may be several active regions, such as active region 245, wherein layer 3 210c and layer 4 210d overlap. An active region 245 may pass high-current, transient signals but block low-level, steady state signals. Each active region 245 serves as an ESD protection device between a protected node 240, and a current-shunt node 241.

In the embodiment of FIG. 2, in addition to the ESD protection device layer 215, the PCB 200 comprises a first layer 210a includes two signal nodes 220 and 221 that may be used to electrically couple an electronic component (not shown) to the PCB 200. Thus, according to this example, the first signal node 220 and the second signal node 221 may be used in tandem to interface a separate component. In this manner, signals may be routed to and from the component through the PCB 200.

Each signal node 220 and 221 may be connected to each layer 210a-210f through respective vias 230 and 231. Thus, a signal at the first signal node 220 may be routed to any other layer 210a-210f through the first via 230. Likewise, a signal at the second signal node 221 may be routed to any other layer 210a-210f through the second via 231. As a result, a routing path for either signal at either signal node 220 and 221 may be provided to the ESD protection layer 215 as shown in FIG. 2 or to any other layer as may be needed for a particular application.

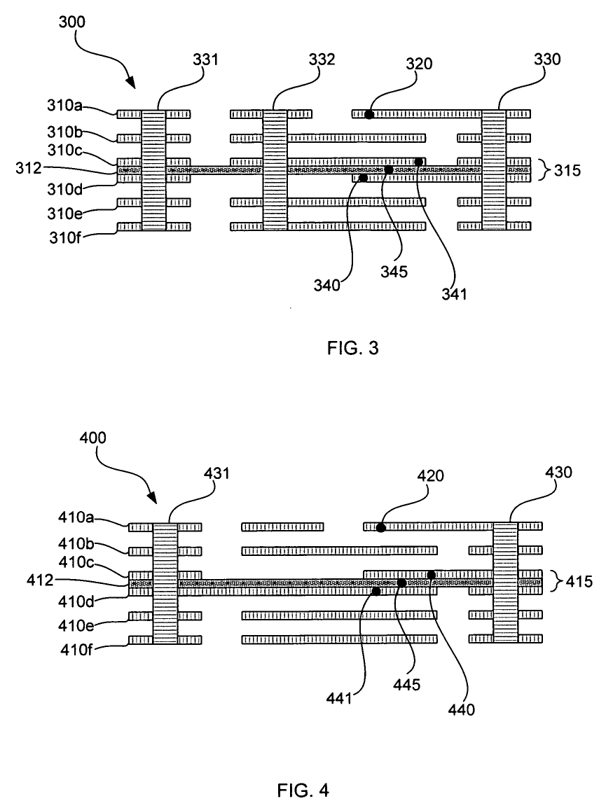

For example, the first signal node 220 is electrically coupled to the first via 230 which provides an electrical coupling to each layer 210a-210f. However, only one other layer (layer 3 210c) is fabricated to carry the signal beyond the via 230. Thus, as shown, any signal at the first signal node 220 will also be present at the protected node on layer 3 210c. If the signal is a normal signal (i.e., not a high-current transient) then the signal does not propagate through the active region 245. However, if the signal is a high-current transient, then the signal does pass through the active region 245 to the current-shunt node 241. The high-current transient may then pass to the second via 231 and eventually to the second signal node 221. The second signal node 221 may typically be a circuit node capable of handling high-current transients, such as a ground terminal and the like. A specific example of a signal pin-to-ground ESD protection scheme is shown below in FIG. 3. For the purposes of this example in FIG. 2, however, a signal pin-to-signal pin ESD protection scheme is shown and has the function of shunting the high-current transients around an electronic component connected between signal nodes 220 and 221

Since different sections of each layer may be isolated during fabrication, layer 3 210c and layer 4 210d may also be fabricated for dual use. That is, in one section, an isolated signal path may be used to route a shunt-current path from a protected node, i.e. an active region 245. However, other sections of either layer may be used as a ground plane or a battery plane for routing these often used signals to many other points in the PCB 200. Thus, as shown in FIG. 2, the section of layer 3 210c that contains the protected node 240 may be isolated from any other section of layer 3 210c. As a result, other areas (not shown) of layer 3 210c may also be used to route a battery signal from a battery (not shown). Likewise, the section of layer 4 210d that contains the current-shunt node 241 may be isolated from any other section of layer 4 210d. As a result, other areas (not shown) of layer 4 210d may also be used to route a ground node coupled to ground (not shown). In this manner, layer 3 210c and layer 4 210d, which are often dedicated to used solely as a battery plane and ground plane respectively, may also serve as ESD devices having active regions 245 for an ESD protection scheme.

Utilizing existing layers in a PCB 200 to realize an ESD protection scheme is advantageous for a number of reasons. For one, no additional layers need to be fabricated for the sole purpose of providing ESD protection. Furthermore, signal routing and signal paths become less complicated and intrusive as typically the ground plane (layer 4 210d, for example) and the battery plane (layer 3, 210c, for example) are often prevalent throughout all areas of the PCB 200. As a result, the circuitry of the PCB becomes less complicated which results in less labor-intensive design and fabrication and smaller PCBs 200. Both of the advantages, in turn, result in cheaper PCB fabrication and design, as well. Depending on the particular routing of the ESD scheme, a more robust dissipation region may be realized within the PCB because of the nature of the semi-conductive dielectric material 212 and its proximity to several ground nodes. Finally, space and money is saved by not having any SMT devices required as part of an ESD protection scheme.

Using the example shown in FIG. 2, an entire ESD protection scheme may be designed using the basic active region routing model of FIG. 2. By providing a routing path from every signal node, such as signal nodes 220 and 221 to the ESD protection layer 215 such that high-current transients will be diverted through an active region 245 of the semi-conductive dielectric layer 212 to a current-shunt node 241, every possible pin combination may be efficiently and effectively protected from ESD. Signal nodes 220 and 221 may represent any signal pin, a ground terminal, a battery terminal, an antenna terminal, and so on. Thus ESD protection may be achieved between any two nodes in an electronic circuit that may be entirely on-board. FIGS. 3-6 show various examples of various protection schemes and methods that may be part of an overall ESD protection scheme realized in a PCB, such as PCB 200.

FIG. 3 is a cutaway view of a PCB 300 showing an ESD protection scheme between a signal node and a ground node according to another embodiment of the invention. As before, a typical PCB 300 may include several layers 310-310f that may be fabricated to realize various interconnections and signal paths to, from, and through the PCB 300. In the embodiment of FIG. 3, the PCB 300 is shown with six distinct conductive plane layers 310a-310f. As in the previous embodiment, layer 3 310c and layer 4 310d may be fabricated to have a semi-conductive dielectric 312 between them. Collectively, layer 3 310c, layer 4 310d, and the semi-conductive dielectric 312 may be referred to as the ESD protection device layer 315.

In the ESD protection device layer 315, there may be several active regions, such as active region 345, wherein layer 3 310c and layer 4 310d overlap. As described previously, an active region 345 may pass high-current transient signals but block low-level, steady state signals. Each active region 345 serves as an ESD protection device between a protected node 340, and a current-shunt node 341.

In the embodiment of FIG. 3, in addition to the ESD protection device layer 315, the PCB 300 comprises a first layer 310a includes a signal node 320 that may be used to electrically couple an electronic component (not shown) to the PCB 300. The signal node 320 may be connected to each layer 310a-310f through a via 330. Thus, a signal at the first signal node 320 may be routed to any other layer 310a-310f through the first via 330. As a result, a routing path for a signal at either signal node 320 may be provided to the ESD protection layer 315 as shown in FIG. 3 or to any other layer 310a-310f as may be needed for a particular application.

Further, FIG. 3 shows a battery via 331 and a ground via 332 that may respectively coupled to a battery and ground (neither shown). Having a respective vias 331 and 332 for battery and ground terminals available at any layer 310a-310f provides ample opportunities for one of these planes to serve as a reference plane for an active region 345. As can be seen in FIG. 3, the current-shunt node 341 is electrically coupled to the ground via 332, thus providing a current-shunt path for dissipating high-current transients to a ground terminal. Thus, a current-shunt path between a signal node 320 and ground 332 is realized and provides ESD protection between these two points in the PCB 300 and the electronic circuit in general.

Similarly, FIG. 4 is a cutaway view of a PCB showing an ESD protection scheme between a signal node and a battery node according to another embodiment of the invention. Again, as before, a typical PCB 400 may include several layers 410-410f that may be fabricated to realize various interconnections and signal paths to, from, and through the PCB 400. In the embodiment of FIG. 4, the PCB 400 is shown with six distinct conductive plane layers 410a-410f. As in the previous embodiments, layer 3 410c and layer 4 410d may be fabricated to have a semi-conductive dielectric 412 between them. Collectively, layer 3 410c, layer 4 410d, and the semi-conductive dielectric 412 may be referred to as the ESD protection device layer 415.

In the ESD protection device layer 415, there may be several active regions, such as active region 445, wherein layer 3 410c and layer 4 410d overlap. As described previously, an active region 445 may pass high-current, transient signals but block low-level, steady state signals. Each active region 445 serves as an ESD protection device between a protected node 440, and a current-shunt node 441.

In the embodiment of FIG. 4, in addition to the ESD protection device layer 415, the PCB 400 comprises a first layer 410a that includes a signal node 420 that may be used to electrically couple an electronic component (not shown) to the PCB 400. The signal node 420 may be connected to each layer 410a-410f through a via 430. Thus, a signal at the first signal node 420 may be routed to any other layer 410a-410f through the first via 430. As a result, a routing path for a signal at the signal node 420 may be provided to the ESD protection layer 415 as shown in FIG. 4 or to any other layer 410a-410f as may be needed for a particular application.

Further, FIG. 4 shows a battery via 431 that may coupled to a battery (not shown). Having a via 431 for battery available at any layer 410a-410f provides ample opportunities for the battery plane to serve as a reference plane for an active region 445. As can be seen in FIG. 4, the current-shunt node 441 is electrically coupled to the battery via 331, thus providing a current-shunt path for dissipating high-current transients to a battery. Thus, a current-shunt path between a signal node 420 and battery 431 is realized and provides ESD protection between these two points in the PCB 400 and the electronic circuit in general.

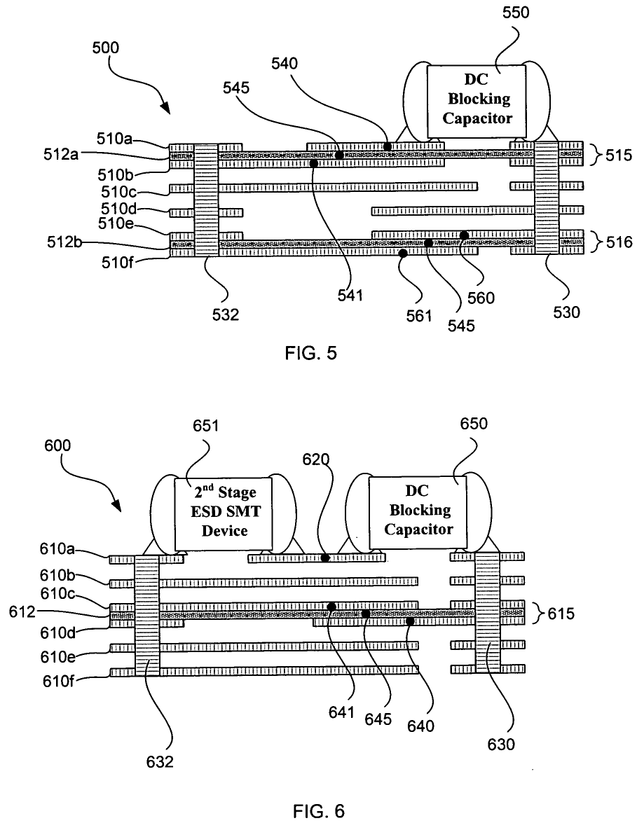

Using a battery plane, a ground plane, and other signal nodes, virtually any two combinations of signal points in a PCB or electronic circuit in general may be encompassed in an ESD protection scheme to provide a shunt-current path through an active region. Providing a single routing path through an active region is referred to as a first stage ESD protection path. More elaborate ESD protection schemes may provide a second stage of ESD protection for several, if not all, possible signal node combinations as well. FIGS. 5 and 6 show two examples of two-stage ESD protection schemes.

FIG. 5 is a cutaway view of a PCB 500 showing a first stage and a second stage of an ESD protection scheme between a first node and a second node according to yet another embodiment of the invention. The embodiment shown in FIG. 5 may also be an IC 500 as is described further below. In the embodiment of the PCB 500, two separate current-shunt paths are available for high-level transients that may be present at the signal node/via 530. As a result, high-level current may be diverted and dissipated through two distinct shunt-current paths, which, in turn, provides a second level of ESD protection to the PCB 500.

In realizing a two-stage ESD protection scheme, and PCB, such as PCB 500, may include two ESD protection layers instead of one as was depicted previously. As can be seen, the PCB 500 in FIG. 5 still includes six layers 510a-510f, however, layer 1 510a, layer 2 510b, and a first semi-conductive dielectric device layer 512a form a first ESD protection layer 515 and layer 5 510e, layer 6 510f, and a first semi-conductive dielectric layer 512b form a second ESD protection device layer 516. As such, more ESD routing options are available and two-stage ESD paths may also be realized more efficiently. Two ESD protection layers 515 and 516, while providing more efficient routing options, are not, however, necessary for realizing two-stage ESD protection schemes as is shown below with respect to FIG. 6.

The embodiment shown in FIG. 5 depicts a shunt/series/shunt two-stage ESD protection for one signal node 530. For example, a high-level transient may be induced at the signal via 530 from an ESD. A portion of the current induced will be diverted to a first protected node 540 (through a DC blocking capacitor 550, that acts to partially absorb the energy of the ESD and isolate the two stages of protection thereby increasing their combined effectiveness) and eventually through a first active region 545 to a first current-shunt node 541 which is electrically coupled to a ground via 532. Similarly a portion of the induced current will be diverted to a second protected node 560 and eventually through a second active region 565 to a second current-shunt node 561 which is also electrically coupled to a ground via 532. Thus, high-level transients are split proportionally through the two current shunt paths and eventually dissipated at ground or to the battery.

In another embodiment, the invention may be practiced in an IC having one or more ESD protection layers disposed therein during IC fabrication. Generally speaking, the above-described aspects of the invention with respect to a PCB, apply equally to an embodiment realized in an IC. One skilled in the art understands that an ESD protection scheme formed in accordance with the present invention may be realized in a PCB or an IC as several concepts apply equally to both implementations. As such, the PCB 500 of FIG. 5 may also be described as an IC 500.

Thus, similar to a PCB embodiment described, the IC 500 in FIG. 5 may include two layers wherein, layer 1 510a, layer 2 510b, and a first semi-conductive dielectric device layer 512a form a first ESD protection layer 515. Additional layers of alternating conductor and semi-conductive materials forming additional ESD protection layers are possible. As was the case before, more ESD routing options are available and multi-stage ESD paths may also be realized more efficiently.

Either of these ESD protection layers 515 and 516 may be fabricated as part of the IC 500, although these layers 515 and 516 may not typically be located at the top and bottom of the die. Thus, during a fabrication process, a single ESD protection layer (for example, layer 515) may be fabricated during a final step in a fabrication process. Further, one skilled in the art understands that although FIG. 5 shows layers 510a-510f as symmetrical, the layers of a PCB may be fabricated to an optimal contour according to an IC's application. Thus, the symmetrical nature of FIG. 5, while desirable in a PCB, may not necessarily be the case in an IC embodiment.

As briefly mentioned above, FIG. 6 is a cutaway view of a PCB 600 showing a first stage and a second stage of an ESD protection scheme between a first node and a second node wherein the second stage includes an SMT device according to yet another embodiment of the invention. In this embodiment, the PCB 600 again includes six layers 610a-610f and includes one ESD protection layer 615 comprised of layer 3 610c, layer 4 610d, and a semi-conductive dielectric layer 612.

The embodiment shown in FIG. 6 depicts a shunt/series/shunt two-stage ESD protection for one signal node 620. For example, a high-level transient may be induced at the signal node 620 from an ESD. A portion of the current induced will be diverted to a first protected node 640 (through a DC blocking capacitor 650) a portion of the current goes through first device 645, is attenuated and the DC level is blocked by capacitor 650, and the remaining current goes through second device 651 to node 632, and eventually through a first active region 645 to a first current-shunt node 641 which is electrically coupled to a ground via 632. Similarly a portion of the induced current is diverted to a SMT ESD device, which eventually diverts current to the ground 632 as well. Thus, high-level transients are again split proportionally through the two current shunt paths and eventually dissipated at ground 632.

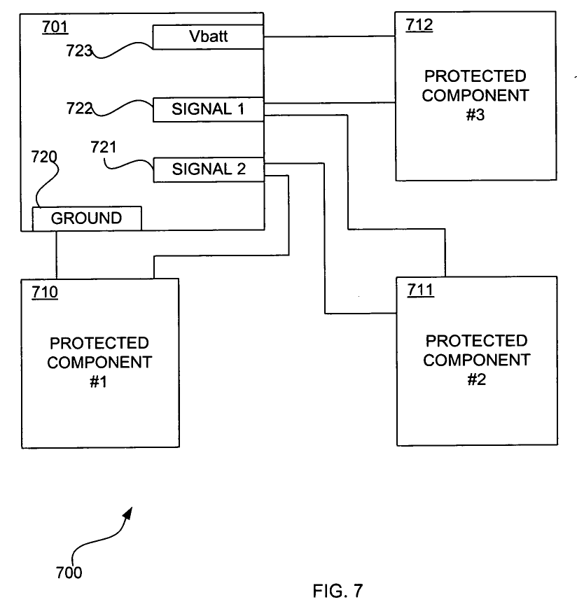

FIG. 7 is a block diagram of an electronic system 700 that includes protected electronic components and a PCB/IC having a configuration for diverting ESD signals away from the protected circuit according to an embodiment of the invention. A PCB/IC 701 may be fabricated to realize ESD protection for one or more sensitive components. For example, the electronic system depicted in FIG. 7 shows a PCB/IC 701 electrically coupled to three protected components 710-712. In this example, the first protected electronic component 710 is coupled to a ground terminal 720 and a first signal node 721. For the first electronic component 710, an ESD routing path similar to FIG. 3 above may be realized to protect the first electronic component 710 from high-level transients.

Similarly, the electronic system depicted in FIG. 7 also shows a PCB/IC 701 electrically coupled to a second protected electronic component 711 via a first signal node 721 and a second signal node 722. For the second electronic component 711, an ESD routing path similar to FIG. 2 above may be realized to protect the first electronic component 711 from high-level transients.

Also similarly, the electronic system depicted in FIG. 7 shows a PCB/IC 701 electrically coupled to a third protected electronic component 712 via ground a second signal node 722 and a battery terminal 723. For the third electronic component 712, an ESD routing path similar to FIG. 4 above may be realized to protect the first electronic component 712 from high-level transients.

Furthermore, additional ESD routing paths may be realized both on and off-board for additional electronic components (not shown). Although shown as off-board in FIG. 7, the depicted electronic components 710-712 may be on-chip and all ESD current-shunt paths are, likewise, realized on-board. As a result, the only external interfaces to the PCB/IC 701 involve signal passing, such as battery and ground. In essence, a PCB/IC fabricated according various embodiments of the invention may be used within any electronic system to provide an ESD protection scheme that realizes a current-shunt path between virtually any two electrical points in the electronic system. Examples of such electronic systems are detailed below.

In one embodiment, a PCB having an ESD protection scheme according to various embodiments of the invention may be realized in a radio frequency (RF) PCB application. As such, various electronic components associated with an RF application may be protected by an ESD scheme such that excessive ESD signals are diverted away from sensitive electronic components in the RF electronic circuit. For example, an RF amplifier is particularly sensitive to high-level transients. Thus, an RF amplifier may be realized either on-board or electrically coupled with a PCB that includes a current-shunt path for diverting these potentially damaging ESD currents away from the RF amplifier. Other components that may be protected from ESD using a PCB having ESD protection scheme include front-end modules, duplexer filters, RF point filters, etc. Of course, virtually any application requiring protection from ESD signals may be implemented in conjunction with a PCB fabricated according to various embodiments of the invention.

In another embodiment, a PCB having an ESD protection scheme according to various embodiments of the invention may be realized in a millimeter-wave PCB application. As such, various electronic components associated with a millimeter-wave application may be protected by an ESD scheme such that excessive ESD signals are diverted away from sensitive electronic components in the millimeter-wave electronic circuit. For example, a monolithic microwave integrated circuit (MMIC) may be particularly sensitive to high-level transients. Thus, an MMIC may be realized either on-board or electrically coupled with a PCB that includes a current-shunt path for diverting these potentially damaging ESD currents away from the MMIC.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

We claim:

1. An electronic circuit for protecting electronic components from electrostatic discharge, the circuit comprising:
an electrostatic discharge protection layer having a first and second conductive layer separated by a semi-conductive dielectric layer; and
a protected node electrically coupled to the first conductive layer and a current-shunt node electrically coupled to the second conductive layer, such that a signal at the protected node that is below a threshold magnitude propagates through the protected node in a normal operating path and a signal at the protected node that exceeds a threshold magnitude is diverted to propagate through the semi-conductive dielectric layer to the current-shunt node in a current-shunt path.

2. The electronic circuit of claim 1 wherein the protected node comprises a signal node.

3. The electronic circuit of claim 1 wherein the current-shunt node comprises at least one type of node from the group of nodes comprising: a signal node, a ground node, and a battery node.

4. The electronic circuit of claim 1 wherein the threshold magnitude comprises a voltage threshold magnitude.

5. The electronic circuit of claim 1 wherein the threshold magnitude comprises a current threshold magnitude.

6. The electronic circuit of claim 1, further comprising a plurality of layers such that the electrostatic discharge layer comprises one layer and at least one protected node is disposed in at least one other layer.

7. The electronic circuit of claim 1, further comprising a second current-shunt node that is part of a second current-shunt path operable to further dissipate a signal that exceeds the threshold magnitude, such that a signal that exceeds the threshold magnitude propagates through a first and second current-shunt nodes proportionally.

8. The electronic circuit of claim 7 wherein the second current-shunt path comprises a path through the semi-conductive dielectric layer.

9. The electronic circuit of claim 7 wherein the second current-shunt path comprises a path through a surface mount electrostatic discharge device.

10. The electronic circuit of claim 1 disposed in an integrated circuit.

11. The electronic circuit of claim 1 disposed in a printed circuit board.

12. An electronic circuit for diverting electrostatic discharge signals, the electronic circuit comprising:
a protection circuit comprising:
an electrostatic discharge protection layer having a first and second conductive layer separated by a semi-conductive dielectric layer; and
a protected node electrically coupled to the first conductive layer and a current-shunt node electrically coupled to the second conductive layer, such that a signal at the protected node that is below a threshold magnitude propagates through the protected node in a normal operating path and a signal at the protected node that exceeds a threshold magnitude is diverted to propagate through the semi-conductive dielectric layer to the current-shunt node in a current-shunt path; and
a protected component electrically coupled to the protection circuit at the protected node, such that electrostatic discharge signals that exceed the threshold magnitude are diverted away from the protected component.

13. The electronic circuit of claim 12 wherein the protected component comprises a millimeter-wave package.

14. The electronic circuit of claim 12 wherein the protected component comprises a radio-frequency amplifier.

15. The electronic circuit of claim 12 wherein the protected component comprises a duplexor filter.

16. The electronic circuit of claim 12 wherein the protected component comprises a radio-frequency point filter.

17. A method for dissipating an electrostatic discharge signal in an electronic circuit, the method comprising:
detecting a signal intended for a normal operating path at a node, the signal exceeding a threshold magnitude;
diverting the signal from the normal operating path to a current-shunt path, the current-shunt path including a semi-conductive dielectric layer and a current-shunt node; and
dissipating the signal at the current-shunt node electrically coupled to the semi-conductive dielectric layer.

18. The method of claim 17, further comprising:
diverting the signal from the normal operating path to a second current-shunt path, the second current-shunt path including a second semi-conductive dielectric layer and a second current-shunt node; and
dissipating the signal at the second current-shunt node electrically coupled to the semi-conductive dielectric layer.

19. The method of claim 17 wherein the dissipating the signal at the current-shunt node comprises dissipating the signal in a ground plane.

20. The method of claim 17 wherein the dissipating the signal at the current-shunt node comprises dissipating the signal in a battery plane.
